(19) United States
(12) Patent Application Publication
(10) Pub. No.: US 2026/0307802 A1
(43) Pub. Date: Oct. 8, 2026

(54) DIVIDER WITH MOVABLE PANELS FOR SIDE-BY-SIDE AIRCRAFT SEATS

(71) Applicant: AIRBUS ATLANTIC, ROCHEFORT (FR)

(72) Inventor: Laurent VIGNON, ROCHEFORT (FR)

(21) Appl. No.: 19/642,401

(22) Filed: Apr. 8, 2026

(30) Foreign Application Priority Data
Apr. 8, 2025 (FR) FR2503717

(51) Int. Cl. B64D 11/06

(52) U.S. Cl. CPC B64D 11/0606

(57) ABSTRACT

A divider (100) between two adjacent aircraft passenger seats, comprising a plurality of movable panels (11, 12, 13) and a housing (20), said divider having a closed position wherein the panels are deployed to form a rigid partition (10) dividing the two seats and an open position wherein the panels are retracted and stored in the housing (20) leaving the two seats connected; the panels (11, 12, 13) being configured to be, in the closed position, vertically aligned in the same plane, and in the open position, stored in the housing (20) along juxtaposed separate parallel planes, switching from one position to the other being ensured by an actuation mechanism comprising at least one motor (311) driving a shaft (115) passing through a first panel (11), and guidance means (316, 317, 326, 327) forcing the panels to move vertically and to be aligned or juxtaposed automatically.

### TECHNICAL FIELD

The present invention relates to the field of aircraft cabin fitting equipment, in particular dividers. More particularly, it relates to a divider with several movable panels for dividing side-by-side seats.

The invention has a direct, but not exclusive, application in business class passenger seats.

### PRIOR ART

In commercial aviation, dividing passengers, in particular in business class, has always represented a technical challenge for designers. Historically, the solutions adopted mainly included curtains suspended from rails, intended to delimit the different service classes within the cabin. However, these curtains had notable drawbacks, including insufficient visual isolation, debatable aesthetics, and limited durability due to mechanical wear. In addition, these solutions are not adapted to adjacent seats for dividing side-by-side passengers, a curtain not being a rigid wall, the movements of one passenger may thus disturb the other passenger.

As passengers'expectations for comfort and privacy have evolved, rigid partitions have been introduced. For example, document EP0361717 describes a divider consisting of individual panels attached to a movable frame along the cabin. Each panel is fastened to the top of a reclining seat and connected to the frame by an expandable-retractable mechanism, enabling the panel to keep a constant position irrespective of the inclination of the seat. Although this design enhances stability and integration with seats, it has limitations in terms of flexibility and adaptability to diverse seat configurations.

Other solutions have attempted to optimize the use of space while enhancing passenger comfort. Document U.S. Pat. No. 8,167,244 proposes an aircraft cabin class partition, positioned immediately behind a row of seats, integrating features such as video monitors and tablets for passengers seated just behind the partition. Nevertheless, this approach is mainly focused on dividing service classes and does not directly address the question of modular division between adjacent passengers in business class.

More recent concepts introduce sofa type seats that can be converted into beds, providing a wider reclining surface. However, these designs are more focused on enhancing passenger position comfort (seated position and reclined position) and do not necessarily incorporate solutions for effective and modular division between two passengers seeking more privacy.

In general, the dividing devices currently provided for aircraft business class suffer from several substantial technical shortcomings when they have to simultaneously reconcile the requirements of modularity, maximum comfort and simplicity of design. Indeed, existing dividers are not capable of providing perfect integration with seats when they are in a bed position. As a result, a significant portion of the divider remains above the reclining level when the seats are fully deployed, creating a physical inconvenience for passengers seeking to use two adjacent seats as a double bed, particularly in the case of couples traveling together. This inconvenience occurs mainly at the ends, i.e. at the passengers'head or feet, on account of the rigid structure of the caisson or panel which remains protruding above the horizontal plane formed by the folded-out seats.

In addition, existing dividers often have non-negligible mechanical complexity, resulting in an increased risk of malfunction. This complexity results particularly from the accumulation of movable mechanical elements and internal mechanisms that are difficult to access during maintenance operations, thus increasing maintenance time and cost. The multitude of parts making up these dividers also results in an unnecessary excess weight, which is particularly problematic in the aeronautical industry where every additional kilogram directly impacts fuel consumption and overall aircraft performances.

Finally, there is now a real difficulty in reconciling the opposite requirements represented by, on the one hand, a divider high enough to ensure complete privacy when passengers do not know each other and, on the other hand, a minimal or non-existent height of the divider when it is deactivated in order to allow passengers who know each other to use the entire reclining surface formed by two adjacent seats fully and without constraint.

To the Applicant's knowledge, no current solution provides perfectly retractable division below the horizontal level formed by the seats folded out into a bed, over the entire available reclining length, while allowing achieving a maximum height when the divider is in the deployed position.

Thus, prior solutions have wavered between flexible curtains but insufficient in terms of isolation, and rigid partitions providing better division but lacking modularity. None of these approaches have fully succeeded in combining effective division, harmonious integration with seats in a reclined position, ease of maintenance and adaptability to the preferences of passengers traveling together or separately, while addressing the fundamental constraints of space, weight and mechanical simplicity essential in the aeronautical sector.

### DISCLOSURE OF THE INVENTION

The present invention aims to overcome all or part of the drawbacks of the prior art disclosed above by providing an innovative solution, making it possible to obtain a rigid divider partition occupying a maximum height in the deployed position, while providing compact and fully concealed storage under the reclining surface, as well as a simplified mechanism ensuring reliability, ease of maintenance and light weight. For this purpose, the present invention relates to a divider between two adjacent aircraft passenger seats, comprising several movable panels and a housing, said divider having a closed position wherein the panels are deployed to form a rigid partition dividing the two seats and an open position wherein the panels are retracted and stored in the housing leaving the two seats connected. This divider is remarkable in that the panels are configured to, in the closed position, be aligned in the same plane and, in the open position, be juxtaposed parallel along separate planes; and in that it comprises an actuation mechanism for switching from one position to another and comprising at least one motor driving a shaft passing through a first panel, and guidance means forcing the panels to move vertically and to be aligned or juxtaposed automatically during their movement.

This configuration a maximum rigid division between passengers while ensuring compact and invisible storage in the open position, thanks to a simple mechanism.

According to one embodiment, the guidance means comprise a first set of sheets and a second set of sheets, said sets being parallel and placed on either side of the panels, said sheets comprising oblong slots wherein guide rings secured to the panels slide, allowing successive actuation of said panels during their movement.

This allows ensuring a progressive transmission of movement between panels, avoiding any jamming or shift during deployment or folding.

More particularly, the oblong slots have lower ends comprising lateral bifurcations configured to force each panel to be positioned automatically in a specific plane when stored in the housing.

This allows automatic tidy storage of the panels, ensuring perfect repeatability of their position and simplifying opening and closing operations.

According to one embodiment, the motor is fastened on a support mounted vertically movable relative to a first caisson by means of a pinion-rack connection comprising a pinion mounted on the shaft driven by the motor, and a fixed rack secured to the first caisson.

More particularly, the shaft comprises at its end opposite the motor a second pinion cooperating with a second fixed rack, said second rack being integrated into a second caisson, ensuring symmetrical actuation of the shaft and avoiding any buttressing phenomenon.

This symmetry of movement provides stability to the panels during movement thereof, eliminating the risks of jamming.

According to one embodiment, each panel has, on at least one of its horizontal edges, a complementary profile forming in the closed position an assembly by rabbet overlap with an adjacent panel, thus ensuring maximum rigidity and visual isolation of the partition.

According to one embodiment, the housing is configured to store the panels in the open position at a height equal to the height of a single panel, thus reducing the vertical space requirement of the divider in the open position.

This facilitates integration the divider in the restricted space available under the seats.

According to one embodiment, there are three panels, an intermediate panel being disposed, in the open position, in a central plane located between two lateral planes respectively occupied by the two other panels, thus forming a compact sandwiched storage configuration in the housing.

The invention also relates to an aircraft passenger seat unit, comprising two adjacent seats convertible into a bed and a divider as described, placed between the two seats.

Advantageously, the housing is disposed under a horizontal surface forming a reclining surface of the seats in a bed position, such that the panels, when they are stored in said housing, remain entirely under said reclining surface; and the partition formed by the deployed panels in the closed position extends longitudinally along a length corresponding to the entire length of said reclining surface.

The fundamental concepts of the invention having been disclosed hereinabove in their most elementary form, other details and features will become more apparent upon reading the following description with reference to the appended drawings, giving, as a non-limiting example, a divider with movable panels, according to the principles of the invention.

### BRIEF DESCRIPTION OF THE FIGURES

The figures are given merely for illustration for a better understanding of the invention without limiting its scope. The different elements may be represented schematically and are not necessarily plotted to scale. Throughout the figures, identical or equivalent elements bear the same reference numeral.

Thus, it is illustrated in:

FIG. 1: a perspective view of a divider in the closed position according to one embodiment of the invention;

FIG. 2: a perspective view of the divider in the open position;

FIG. 3: a top view of the divider in the closed position (a) with overlaid panels in the same plane, and in the open position (b) with parallel juxtaposed panels;

FIG. 4: an isolated and perspective view of the panels of the divider in the closed position forming a coplanar partition, with a detailed view on the overlap between successive panels;

FIG. 5: an isolated and perspective view of the panels of the divider in the open position, stored parallel over a reduced height;

FIG. 6: a kinematic diagram of the divider in the open position;

FIG. 7: a kinematic diagram of the divider in the closed position;

FIG. 8: a detailed view on the lower ends of the oblong slots cooperating with guide rings of the panels;

FIG. 9: a diagram of movement of the panels between the closed position and the open position, showing the operation of the guidance means;

FIG. 10: a partial view of the actuation mechanism in the first caisson of the divider in the closed position;

FIG. 11: a partial view of the actuation mechanism in the first caisson of the divider in the open position;

FIG. 12: a partial view of the actuation mechanism in the two opposite caissons of the divider in the closed position.

### DETAILED DESCRIPTION OF EMBODIMENTS

In the embodiment described hereinafter, reference is made to a divider with movable panels intended to be installed between two adjacent aircraft seats, allowing passengers to be visually and physically isolated when they do not know each other, while offering the option of complete opening and perfect integration under the reclining surface formed by these same seats when they are converted into a double bed. This divider is particularly adapted to passenger seats in the business class of an airliner, but may be used in another transport vehicle providing the same level of comfort and service.

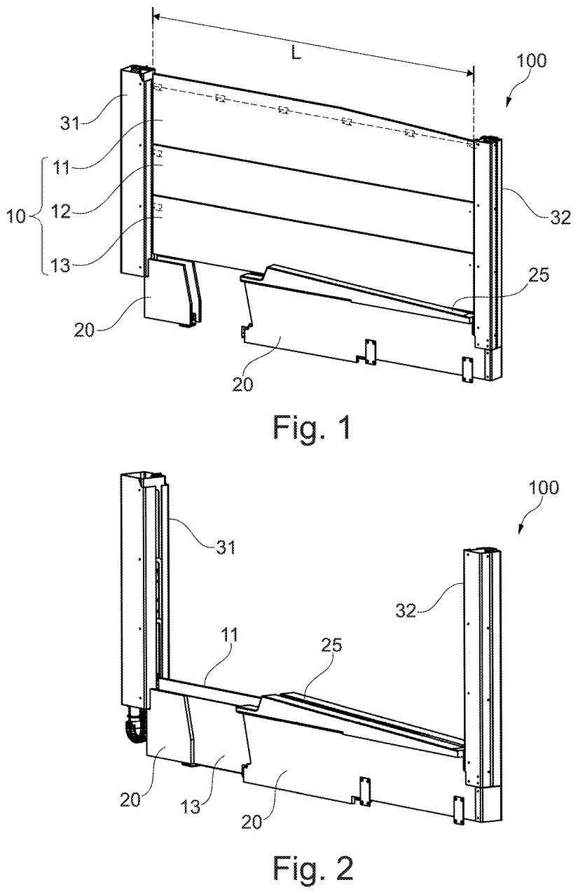

FIG. 1 shows a divider 100 intended to be installed between two adjacent seats, not shown, illustrated here in the closed position. The divider 100 comprises three movable panels 11, 12 and 13, forming a partition 10. These panels have a generally rectangular geometry and are disposed in the same vertical plane so as to form a uniform and continuous surface together, thereby ensuring an optimum visual and physical division between the two passengers when the divider 100 is in this closed position.

The three panels 11, 12 and 13 are configured to move relative to one another, allowing their compact and discreet storage in a storage housing 20 when the divider 100 is in the open position. This housing 20, located under the horizontal surface formed by the adjacent seats, has a reduced height so as to be capable of being readily concealed under the reclining surface of the seats in a bed position, while providing a storage capacity adapted to receive the entirety of the parallel stacked panels 11, 12, 13.

The housing 20 moreover has an upper longitudinal extension 25, shaped to optimally adapt to the shape of the seats.

The divider 100 further comprises two vertical caissons, a first caisson 31 and a second caisson 32, disposed respectively at the left and right ends of the panels 11, 12 and 13. Each of these caissons 31, 32 contains a portion of an actuation mechanism allowing deployment and folding of the panels 11, 12 and 13 between their deployed (closed) position and their stored (open) position. These internal mechanisms will be described in detail later on with reference to the following figures.

The vertical caissons 31 and 32 are intended to be rigidly fastened to the immediate structural environment of the adjacent seats. They ensure sufficient mechanical stability to withstand the loads associated with repeated handling of the panels.

The partition 10 formed by the movable panels 11, 12, 13 extends longitudinally over a length L corresponding to the entire length of the reclining surface available when the adjacent seats are converted into a bed position. By way of non-limiting example, this length L may extend from the top of the backrest to an ottoman extending the seat, thus allowing complete division of the passengers, without discontinuity, over the entire usable reclining length provided by the seats in a bed position.

Variants may provide for an adjustment of the height and width of the panels to accurately fit to different passenger seat models and configurations.

FIG. 2 shows the divider 100 in its open position. In this configuration, the movable panels 11, 12 and 13 (the panel 12 being hidden in this view as it is located behind the panel 11) are entirely stored in the storage housing 20, such that their presence does not generate any inconvenient or discontinuity above the reclining surface of the adjacent seats.

More specifically, the panels are juxtaposed parallel to one another within the housing 20, thus forming a particularly compact assembly allowing a significant reduction of the vertical space requirement under the seats. The panel 11, here seen in its upper portion, is thus positioned in a central plane, whereas the panel 13, seen in the foreground, is moved in a first lateral plane. The last panel (not seen herein) is housed along a lateral plane on the other side of the central plane, thereby ensuring an optimized storage in a sandwiched configuration.

The housing 20, provided with its longitudinal upper extension 25, precisely molds the lower contour of the adjacent seats for superior integration and to facilitate the storage and extraction movements of the panels.

Thus, the divider 100 has a design allowing switching from a fully deployed partition into a completely clear surface, without any protruding part capable of disturbing the reclining area when the adjacent seats are used in a double bed position.

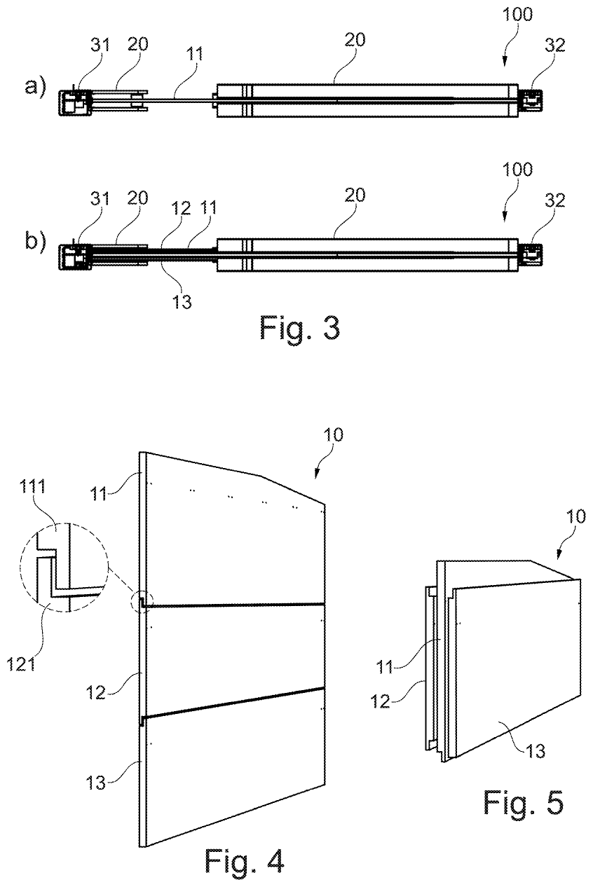

FIG. 3 makes it possible to better visualize the arrangement of the panels 11, 12 and 13 in the two positions of the divider 100.

More specifically, view (a) illustrates the closed position of the divider 100, in which the three panels 11, 12, 13 are perfectly overlaid in the same vertical plane. With this coplanar overlay, only the upper panel 11 can be seen directly in this view. This arrangement ensures a homogeneous and continuous partition over the entire height of the divider.

View (b) of FIG. 3 corresponds for its part to the open position of the divider 100. It allows clearly visualizing the parallel juxtaposition of the three movable panels 11, 12 and 13 stored in the storage housing 20. This view particularly highlights the sandwiched arrangement mentioned above, with the panel 11 located in an intermediate central plane, whereas the panels 12 and 13 are each stored in a lateral plane on either side of this central panel.

FIG. 4 shows an isolated view of the panels 11, 12 and 13 forming the partition 10. This illustration allows a better understanding of the individual geometry and mode of assembly of these panels in the closed position. Each panel is provided with a specific profile on its opposite horizontal edges ensuring a rabbet overlap assembly.

More specifically, the panel 11 has a rabbet 111 interlocking precisely with a complementary rabbet 121 formed on the adjacent panel 12. This assembly principle, similar between each pair of successive panels, ensures both structural rigidity and increased isolation between passengers, avoiding any free space or discontinuity in the deployed partition.

FIG. 5 shows the folded partition 10 in a storage position, with parallel juxtaposed panels 11, 12 and 13 occupying substantially the same height. Thus, the folded partition 10 can be stored in a volume of reduced height relative to the maximum height achievable by said deployed partition. In the example illustrated, the height occupied by the folded partition does not exceed that of the panel 11, which is substantially equal to the height of the other panels, and which therefore corresponds to about one third of the maximum dividing height.

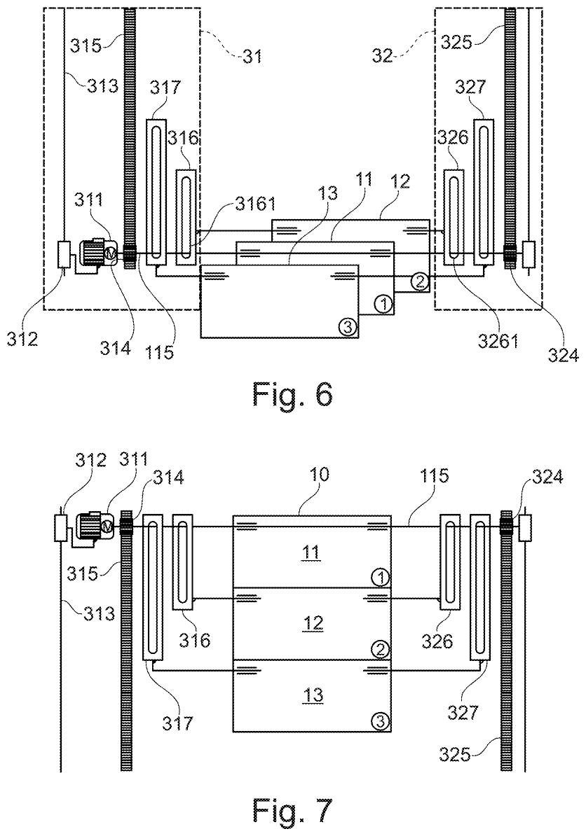

FIG. 6 shows the general kinematic diagram of the actuation mechanism of the divider 100, illustrated in the open position. The mechanism comprises a rotary electric motor 311, fastened to a support 312. The support 312 is in turn mounted on a vertical slide 313 integrated in the first caisson 31 which is intended to be fastened to one of the adjacent seats.

The motor 311 rotates a pinion 314, mounted on a longitudinal shaft 115 entirely passing through the first panel 11. This pinion 314 cooperates with a fixed rack 315, secured to the caisson 31, to ensure precise vertical movement of the motor 311 and hence of the panel 11.

At the opposite end of the shaft 115, a second pinion 324 is provided, which is in a pinion-rack connection with a second fixed rack 325 integrated into the second caisson 32, positioned opposite the first caisson 31 and intended, for example, to be fastened to one of the ottomans of the adjacent seats.

A clevis 3261 makes it possible to ensure a pivot-sliding link between this second pinion 324 and the caisson 32. Thus, the movement of the panel 11 is symmetrically guided, thus avoiding any buttressing phenomenon during its vertical movement.

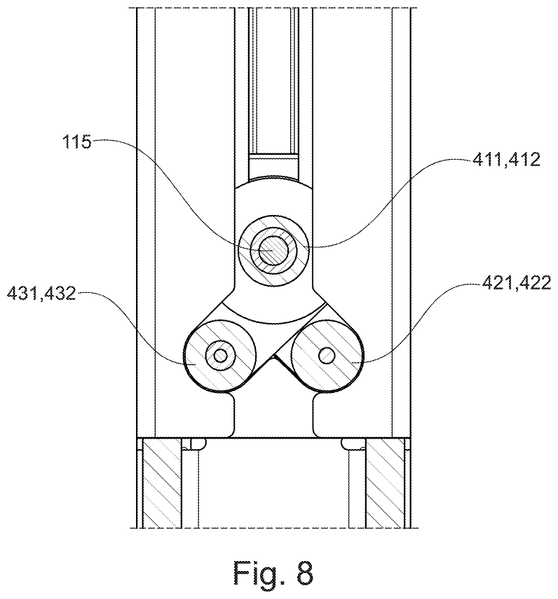

FIG. 7 shows the kinematic diagram of the divider in the closed position, illustrating the links ensuring the successive actuation of the panels 11, 12 and 13 during the deployment phase. More specifically, the shaft 115 is equipped with two opposite guide rings, referenced respectively 411 and 412 in FIG. 8, allowing precise sliding of said shaft in slots formed within the caissons 31 and 32.

Furthermore, the shaft 115 comprises a set of coils which cooperate successively with sets of specifically profiled sheets. A first set of sheets 316 and 326 is positioned on either side of the panels, each sheet comprising an oblong slot allowing sliding guidance of the coils. The sheets 316 and 326 are connected to the second panel 12 by a pivot-sliding link equipped with two guide rings, referenced 421 and 422 in FIG. 8.

During the vertical movement of the panel 11, when the coils of the shaft 115 reach the stops of the slots of the sheets 316 and 326, the second panel 12 is in turn actuated vertically.

Still with reference to FIG. 7, a second set of sheets 317 and 327 is fastened symmetrically on the opposite sides of the intermediate panel 12. These sheets also comprise oblong slots similar to the first, wherein a second portion of the coils slides. These sheets 317 and 327 are fastened on the third panel 13 via a pivot-sliding link comprising two guide rings, referenced 431 and 432 in FIG. 8. Thus, after the coils have reached the ends of the slots of the sheets 317 and 327, the third panel 13 is actuated vertically and is perfectly aligned with the two other panels already deployed, thereby making up the complete and coplanar partition 10.

FIG. 8 details specifically the internal guidance system within the caisson 31 (the mechanism being symmetrical in the caisson 32). The shaft 115 is equipped with the two rings 411 and 412, which ensure an accurate guidance in a longitudinal slot formed in the caisson 31. Two other complementary guide rings 421 and 422 cooperate with the intermediate sheets 316 and 326 during the deployment movement of the successive panels as shown in FIGS. 6 and 7.

Finally, two last rings 431 and 432 allow ensuring guidance of the third panel 13 in the final phase of deployment thereof and during storage thereof. When the divider is lowered to its open position (stored position), the rings 431 and 432 of the third panel 13 slide into two specific slots making it possible to orient this panel precisely toward its storage location. The rings 421 and 422 of the second panel 12 are guided on one side by the same slots as those of the third panel, and on the other side by the rings 431 and 432 themselves, thus ensuring precise automatic sorting of the three panels when they are folded into the storage housing.

The operating mechanism thus described, based on successive sets of pinion-rack connections and accurate guidance by rings and sheets with oblong slots, guarantees both smooth deployment, accurate alignment of the panels and optimized storage, while considerably reducing the mechanical complexity compared to solutions known in the prior art.

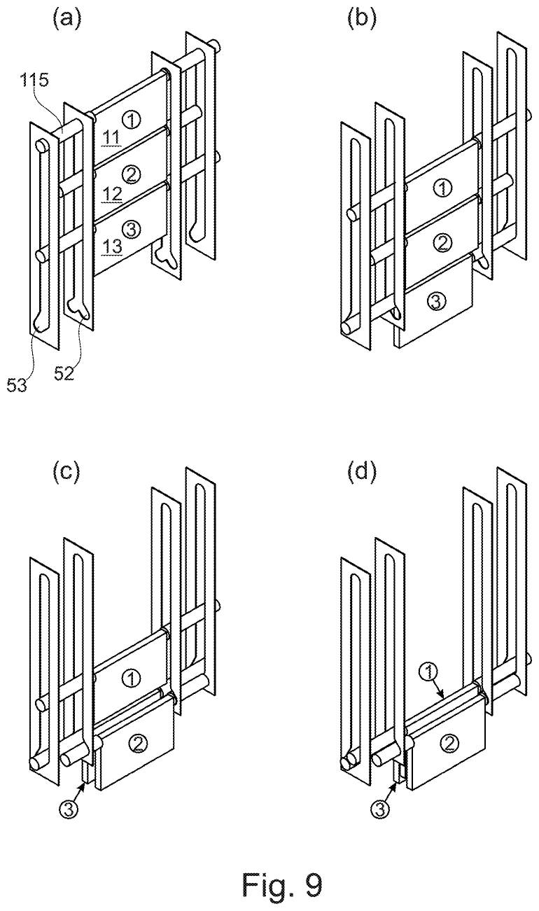

FIG. 9 schematically shows the kinematic sequence allowing tidy storage of the panels 11, 12 and 13 in their open position within the storage housing. To achieve this storage, each panel comprises equipped with coils cooperating with sliding slots. These slots have specifically profiled lower ends, designated by the references 52 and 53, intended to successively guide and force the panels in their respective final position.

In configuration (a), the panels 11, 12 and 13 are in their initial aligned position corresponding to the closed position of the divider. In this configuration, the shafts provided with the coils are all aligned in the rectilinear upper portions of the slots. The storage sequence is started by a downward vertical movement of the group of panels.

In configuration (b), as the panels are lowered, the shafts progressively reach the lower zones of the slots. The lower end 53 has a lateral bifurcation oriented to the left, which forces the shaft associated with the lower panel 13 to move laterally toward this left branch. This precise guidance causes a lateral deviation of the panel 13 relative to the intermediate panel 12 and the upper panel 11.

In configuration (c), the lowering of the panels continues, and the shafts associated with the panels progressively reach the lower end 52 of the slots. This end 52 comprises two lateral branches, one to the left and one to the right. One of these branches is already occupied by the shaft of the previously deviated lower panel 13. The second available lateral branch then receives the shaft of the intermediate panel 12, causing an opposite lateral offset of this panel relative to the panel 13. At this stage, the two lower panels (12 and 13) are therefore located in two parallel and separate lateral planes.

Finally, configuration (d) shows the final panel storage position. In this last step, the upper panel 11 continues to be lowered to take position in a central plane located between the two lateral planes occupied by the panels 12 and 13. Thus, upon completion of this storage sequence, the three panels occupy precisely the three juxtaposed parallel positions according to the previously-described sandwiched configuration.

It should be noted that the reverse movement, i.e. an upward vertical movement of the panels from configuration (d), automatically and symmetrically results in progressive alignment of the three panels 11, 12 and 13 in the same vertical plane, defined by the rectilinear upper portion of the slots. Thus, this mechanism allows a reliable and repeatable transition between the open and closed positions of the divider while minimizing the risks of jamming.

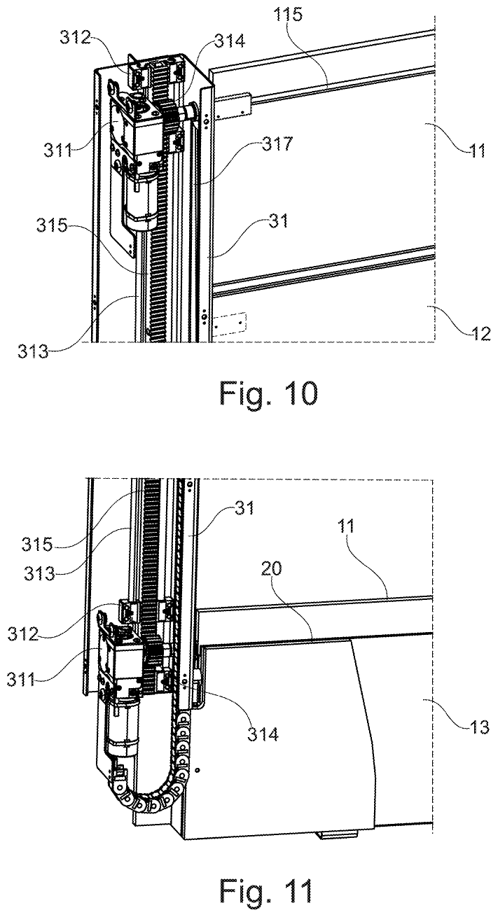

FIG. 10 shows a detailed view of the upper portion of the actuation mechanism integrated in the first caisson 31, in the high position of the divider (closed position). In particular, the mechanism comprises the rotary electric motor 311 rigidly fastened on the support 312, which is in turn mounted on the vertical slide 313, allowing a movement of the motor/support assembly in the vertical direction. This movement is ensured by a pinion-rack link formed by the drive pinion 314, mounted on the longitudinal shaft 115 of the motor 311, and the fixed vertical rack 315 integrated in the caisson 31. Thus, the rotation of the motor 311 causes a translation of the motor itself, simultaneously actuating the vertical movement of the upper panel 11 to which the axis 115 is secured. A distinction is also made between the guide sheets 317 with oblong slots, intended for guiding the movement of the panels during movement thereof.

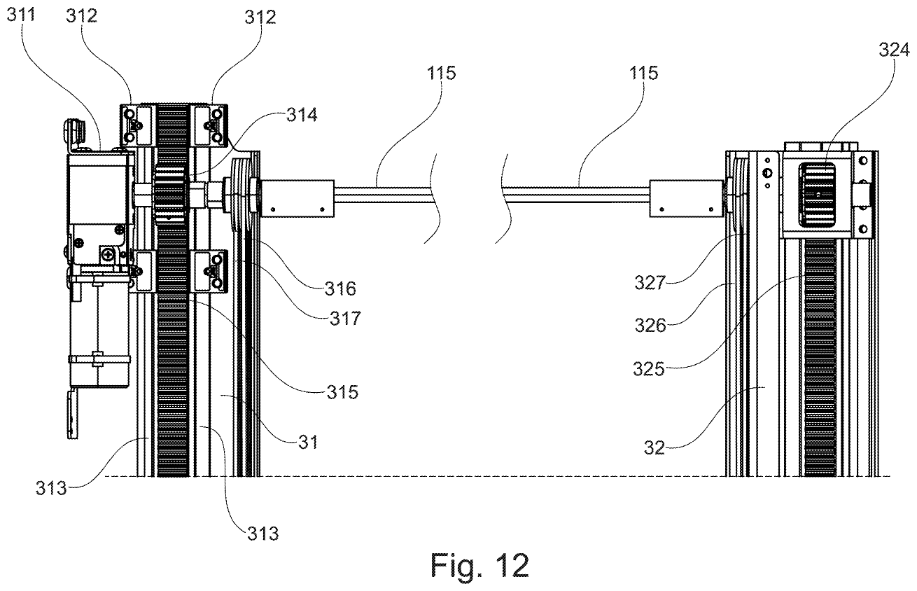

FIG. 11 shows a view similar to that of FIG. 10, but with the mechanism in the low position, corresponding to the storage position (open position) of the divider. The motor 311 here, still fastened to the support 312, has been moved downward along the slide 313, thanks to the cooperation of the pinion 314 and the rack 315. In this position, the movable panels (here illustrated by the panels 11 and 13) are entirely stored in the storage housing 20 located under the horizontal surface of the adjacent seats. In order to ensure protection and optimum management of electrical cables during repeated movements of the motor 311, an articulated cable-holder chain may be provided to vertically accompany the movement of the motor.

FIG. 12 shows a complete and symmetrical view of the actuation mechanism of the panels, connecting the two opposite caissons 31 and 32 by the longitudinal shaft 115 passing through the movable panels. As described before, on the side of the first caisson 31, the shaft 115 is secured to the drive pinion 314 cooperating with the fixed vertical rack 315. Slides 313, combined with pads fastened to the support 312, ensure precise linear guidance of the motor/support assembly during its movements. The figure also clearly shows the intermediate guide sheets 316 and 317 disposed in the caisson 31.

At the opposite end of the shaft 115, the mechanism comprises the second pinion 324 in a pinion-rack link with the second fixed vertical rack 325 integrated in the second caisson 32. As for the first caisson, symmetrical guide sheets, here referenced 326 and 327, are present to ensure a perfectly symmetrical movement and without lateral stress of the panels.

1. A divider between two adjacent aircraft passenger seats, comprising several movable panels and a housing, said divider having a closed position wherein the panels are deployed to form a rigid partition dividing the two seats and an open position wherein the panels are retracted and stored in the housing leaving the two seats connected, wherein:
the panels are configured to, in the closed position, be aligned in the same plane and, in the open position, be juxtaposed in parallel along separate planes;
it comprises an actuation mechanism for switching from one position to another and comprising at least one motor driving a shaft passing through a first panel, and guidance means forcing the panels to move vertically and to be aligned or juxtaposed automatically during their movement.

2. The divider according to claim 1, wherein the guidance means comprise a first set of sheets and a second set of sheets, said sets being parallel and placed on either side of the panels, said sheets comprising oblong slots wherein guide rings secured to the panels slide, allowing successive actuation of said panels during their movement.

3. The divider according to claim 2, wherein the oblong slots have lower ends comprising lateral bifurcations configured to force each panel to be positioned automatically in a specific plane when stored in the housing.

4. The divider according to claim 1, wherein the motor is fastened to a support mounted vertically movable relative to a first caisson by means of a pinion-rack link comprising a pinion mounted on the shaft driven by the motor, and a fixed rack secured to the first caisson.

5. The divider according to claim 4, wherein the shaft comprises at its end opposite to the motor a second pinion cooperating with a second fixed rack, said second rack being integrated into a second caisson, guaranteeing a symmetrical actuation of the shaft and avoiding any buttressing phenomenon.

6. The divider according to claim 1, wherein each panel has, on at least one of its horizontal edges, a complementary profile forming in the closed position an assembly by rabbet overlap with an adjacent panel, thereby ensuring maximum rigidity and visual isolation of the partition.

7. The divider according to claim 1, wherein the housing is configured to store the panels in the open position at a height equal to the height of a single panel, thus reducing the vertical space requirement of the divider in the open position.

8. The divider according to claim 1, wherein there are three panels, an intermediate panel being disposed, in the open position, in a central plane located between two lateral planes respectively occupied by the two other panels, thus forming a compact sandwiched storage configuration in the housing.

9. An aircraft passenger seat unit, comprising two adjacent seats convertible into a bed and wherein further comprising a divider according to claim 1, said divider being placed between the two seats.

10. The seat unit according to claim 9, wherein the housing is disposed under a horizontal surface forming a reclining surface of the seats in a bed position, such that the panels, when stored in said housing, remain entirely under said reclining surface, and wherein the partition formed by the panels deployed in the closed position extends longitudinally along a length (L) corresponding to the entire length of said reclining surface.
